(19) United States
(12) Patent Application Publication
(10) Pub. No.: US 2007/0269765 A1
(43) Pub. Date: Nov. 22, 2007

(54) ROOT CANAL INSTRUMENT

(75) Inventors: Karl-Heinz Danger, Detmold (DE); Frank Hagemann, Lemgo (DE); Frank Ponzel, Detmold (DE)

Correspondence Address: SHERIDAN ROSS PC, 1560 BROADWAY, SUITE 1200, DENVER, CO, 80202, US

(73) Assignee: GEBR. BRASSELER GMBH & CO. KG, Lemgo (DE)

(21) Appl. No.: 11/567,016

(22) Filed: Dec. 5, 2006

(30) Foreign Application Priority Data
Dec. 5, 2005 (DE) 10 2005 057 996.5

(51) Int. Cl. A61C 3/02

(52) U.S. Cl. 433/144

(57) ABSTRACT

The invention relates to a root canal instrument having a shaft 1 being connected to a neck 2, a head 4 having at least one cutting edge 3 being arranged at the free end thereof, wherein the cutting edge 3 along the head 4 is provided with a positive twisting angle from a region facing the tip 5 of the head 4 and a negative twisting angle in a region facing the neck 2.

### CROSS REFERENCE

This application claims the benefit of German Application Serial No. 10 2005 057 996.5, filed Dec. 5, 2005, the entire disclosure of which is hereby incorporated herein by reference.

### DESCRIPTION

The invention relates to a root canal instrument according to the features of the preamble portion of claim 1.

In detail, the invention relates to a root canal instrument which is particularly configured as a root canal expander. Such root canal expanders mainly serve to expand the canal entry of the root canal such that it is accessible with preparation instruments or root canal instruments to be used subsequently. Further, the root canal expanders serve to generate an opening in the root canal, into which a root pin may be inserted precisely fittingly.

Root canal expanders are described in ISO standard 3630-2. Similar instruments known from the state of the art are shown in EP 0 444 155 B1, U.S. Pat. No. 453,254, U.S. Pat. No. 5,735,690 or U.S. Pat. No. 4,661,061.

It has proven to be disadvantageous in the root canal instruments known from the state of the art that same often cannot withstand the occurring stress and break down by breakage.

From AT 83087, a drill is pre-known in which the chip discharging grooves extend on both sides symmetrically and in waves. The chips are conveyed through the chip discharging grooves by main cutting edges formed at the top of the drill.

Same do not form any auxiliary cutting edges. The drill therefore only cuts by using the main cutting edges of its cone-shaped front face as well as the cross cutting edge provided therein.

From DIN EN ISO 3520-2:2001-09, root canal instruments for dentists are pre-known, the working parts of which are provided with lateral, helical cutting edges, in order to ream the root canals and to enlarge the opening of the coronary part of the root canal. Said working parts can be formed cylindrically, crowned or flame-shaped.

DE 696 08 101 T2 shows an endodontic set of instruments having a plurality of conical root canal files which are respectively provided with cutting edges at their outer periphery and are employed successively.

A rotating drilling or milling tool for medical and dental bone and dentin processing is known from DE 91 07 924 U1. This tool serves to process bones or dentin and is made of tungsten or a tungsten alloy.

DE 698 19 969 T2 discloses a drill having chip grooves with alternating helical and straight sections. Therein, the shape of the chip groove may be provided with a positive or negative lead angle, wherein the average lead angle over the complete length of the instrument must be positive, since otherwise the removed material is not discharged by the rotational movement of the instrument.

It is the object of the invention to provide a root canal instrument of the aforementioned kind, which avoids the drawbacks of the state of the art while offering a simple structure and a simple and economic manufacturing, which features a good strength and enables a reliable root canal preparation.

According to the invention, this object is solved by the combination of features of the main claim, the sub-claims disclose further advantageous embodiments of the invention.

Therewith, a root canal instrument was created according to the invention, which is provided with different twisting angles along the length of its head. These different twisting angles are formed such that the root canal instrument may be used in an advantageous matter in the forward motion, during which a normally clockwise feed motion into the root canal occurs, as well as in the reverse direction. During both of these motions (forward and reverse motion), the chips or tissue particles are removed coronal from the root canal and not conveyed apical into the channel. Through this, the inventive root canal instrument differs from the root canal instruments known from the state of the art, in which the chip material or tissue material is removed coronal during the forward motion, however, in case of the reverse motion, the chips or tissue particles are pushed toward the tip of the root canal instrument and thus toward the tip of the root canal. This results in an increased friction, deadlocks and an increased effort, which finally may lead to a failure of the root canal instrument by breakage.

Due to the different twisting angles provided in the invention, the inventive root canal instrument may be reliably used in the forward motion as well as in the reverse motion.

According to the invention, the cutting edge has a twisting angle of 0° in the transitional area from the positive to the negative twisting angle.

The respective lengths of the heads, being provided with the different twisting angles, may be easily adapted to the respective requirements, in particular to different shapes of the heads (e.g. flame-shaped). According to the invention, it is advantageous if the middle region of the head, with respect to a plane being perpendicular to the rotary axis, is formed substantially symmetrically. This means that starting from the region in which the twisting angle is 0°, respectively adjacent head portions are provided which are symmetrical to one another and therewith have the same course of twisting angle.

The inventive root canal instrument may be provided with two cutting edges, three cutting edges or four cutting edges.

In a particularly preferable embodiment of the invention, it is provided that the root canal instrument is made of nickel-titanium. In addition, it is possible to provide same with a titanium nitride coating in order to minimize wear and increase service life.

In the following, the invention is described on the basis of an embodiment with reference to the drawing, wherein

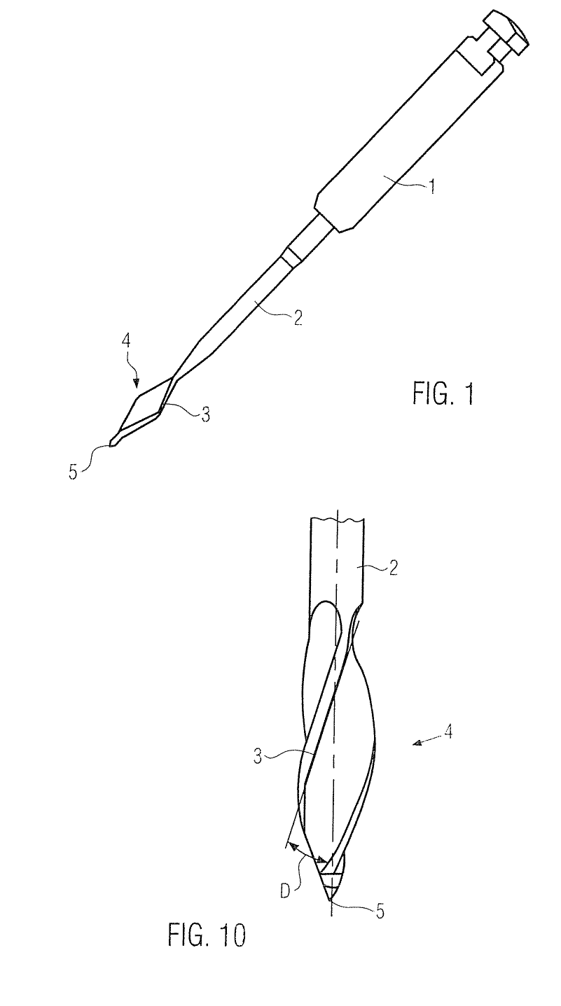

FIG. 1 shows a perspective view of an inventive root canal instrument,

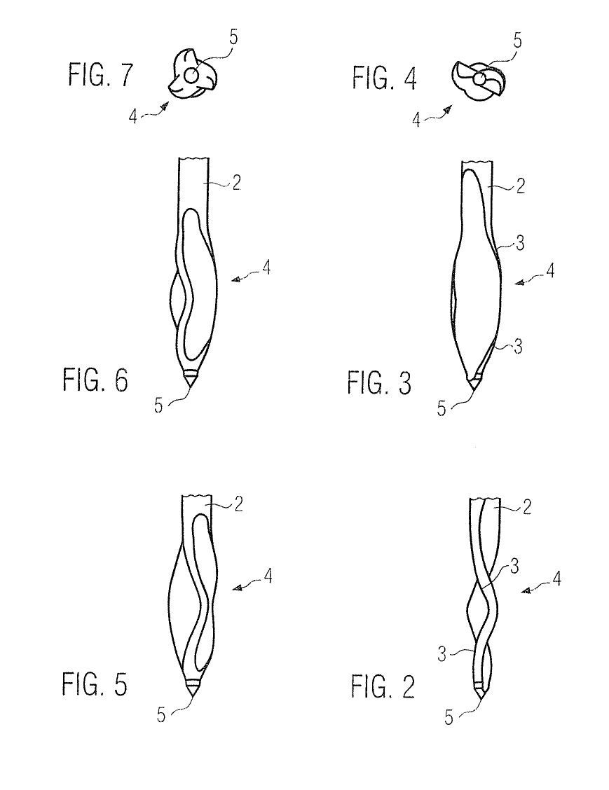

FIG. 2 shows a lateral view of the head of the embodiment shown in FIG. 1,

FIG. 3 shows a lateral view of the head in a rotated view with respect to FIG. 2,

FIG. 4 shows a top view of the head with the embodiments of FIGS. 2 and 3, also having two cutting edges,

FIGS. 5 to 7 show views analogous to FIGS. 2 to 4 of an embodiment having three cutting edges,

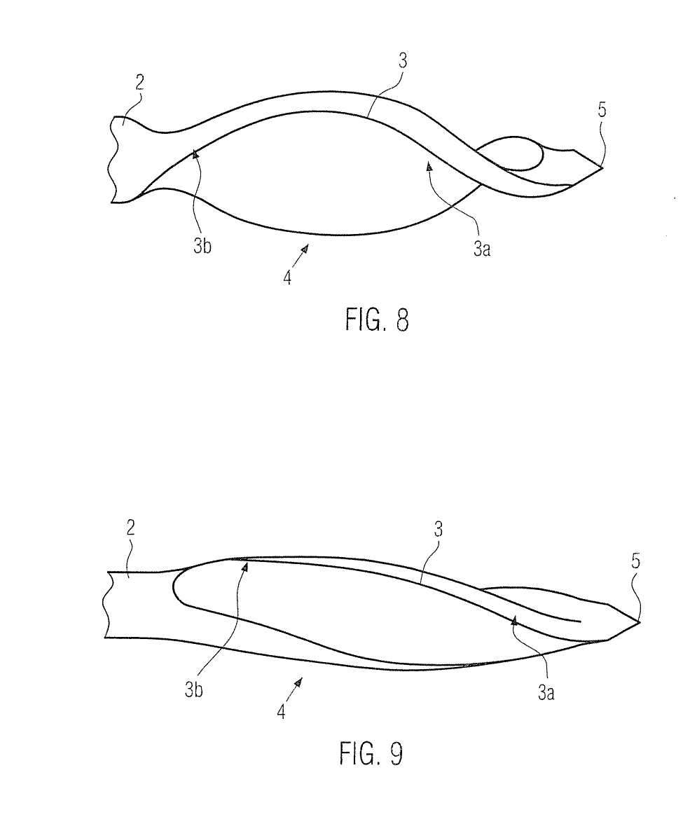

FIG. 8 shows an enlarged lateral view of an embodiment having two cutting edges in order to clarify the function,

FIG. 9 shows a lateral view analogous to FIG. 8 of an embodiment according to the state of the art, and

FIG. 10 shows a lateral view of a head according to the state of the art.

In the following embodiments, identical parts are designated with identical reference numerals.

FIG. 10 shows a lateral view of a head of a root canal instrument known from the state of the art. Same comprises a head 4 which is connected integrally with a neck 2. The head 4 comprises a tip 5. The neck 2 is connected integrally with a shaft (see FIG. 1) which is provided with the usual clamping means. In this context, reference is made to the state of the art. The same applies for the remaining dimensions (lengths, diameters, etc.). They result in particular from ISO 3630-2.

As can be seen from FIG. 10, the head 4 comprises three cutting edges. The twisting angle D results, in usual definition, relative to the center axis or rotary axis. Said angle naturally changes in view of its amount along the course of the cutting edge 3, since the head 4 is formed flame-shaped in the lateral view.

FIG. 1 shows a lateral view of an embodiment of the inventive root canal instrument having two cutting edges. The head 4 as well as the neck 2 are formed integrally and are e.g. made of nickel-titanium. The shaft may be manufactured from plastics. Enlarged illustrations of the head are shown in FIGS. 2 to 4. Therein, it is in particular discernible that the twisting angle (see in particular FIG. 2) changes from a positive twisting angle for a clock-wise forward motion in the front region of the head 4 to a negative twisting angle for a reverse motion (clock-wise) in the rear portion of the head facing the region designated with 2. In a middle region of the head 4, the twisting angle is 0°. The depiction of FIG. 3 being rotated by 90° again clarifies the correlations.

In FIGS. 5 to 7, views (analogous to FIGS. 2 to 4) of a head having three cutting edges are shown. Therein, analogue correlations occur, as in the illustrations of FIGS. 2 to 4.

FIGS. 8 and 9 show lateral views of an inventive head (FIG. 8) as well as a head known from the state of the art (FIG. 9). From this, it is discernible that the active cutting edge, designated with reference numeral 3a, for the forward motion in both heads is formed, with respect to its twisting angle, such that chips or tissue particles are removed or conveyed coronal, i.e. in direction of the neck 2, from the root canal. Upon a reverse motion, the cutting edge 3 is still in engagement. The cutting edge 3 is, in a usual manner, provided with a free grinding such that the chip geometries occur which are also known from the state of the art. There is no need to discuss this in detail herein. The portion of the cutting edge being active in a reverse motion is designated with reference numeral 3b. From the illustrations of FIGS. 8 and 9, there results that, according to the invention (FIG. 8), this active portion 3b of the cutting edge is formed such that the chips, upon a reverse rotation, are still removed coronal out of the root canal. Contrary thereto, the active portion 3b of the cutting edge being active upon a reverse motion is formed such that the chips or tissue particles are transported toward the tip of the instrument and therewith result in that the root canal is clogged by the chips.

The invention is not restricted to the shown embodiments as well as the dimensions and configurations of the head of the root canal instrument. In particular, the invention is not restricted to root canal expanders, but may also be employed in other root canal instruments. It is as well possible to provide a dual-conical head or similar other head shapes instead of a flame-shaped head.

### LIST OF REFERENCE NUMERALS

1 shaft
2 neck
3 cutting edge
4 head
5 tip
D twisting angle

1. A root canal instrument comprising a shaft being connected to a neck, a head having a tip and having at least one cutting edge being arranged at a free end of the head, said at least one cutting edge having a positive twisting angle from a region facing the tip of the head and a negative twisting angle in a region facing the neck, wherein said at least one cutting edge has a twisting angle of 0° in a transitional area from a positive to a negative twisting angle, wherein a middle region of the head, relative to a plane being perpendicular to a rotary axis of the head, is formed substantially symmetrically and the head is formed flame-shaped in a lateral view.

2. The root canal instrument of claim 1, wherein the head has two cutting edges.

3. The root canal instrument of claim 1, wherein the head has three cutting edges.

4. The root canal instrument of claim 1, wherein the head has with four cutting edges.

5. The root canal instrument of claim 1, wherein an active portion of the cutting edge, which faces the tip of the head, is formed to remove chips coronal upon a forward motion of the root canal instrument and that an active portion of the cutting edge, which faces the neck, is formed to remove the chips coronal upon a reverse motion of the root canal instrument.

6. The root canal instrument of claim 1, wherein the root canal instrument is configured as a root canal expander.

7. The root canal instrument of claim 6, wherein said instrument is configured as a Gates type root canal expander.

8. The root canal instrument of claim 1, wherein said instrument is configured substantially according to ISO 3630-2.

9. The root canal instrument of claim 1, wherein said instrument is formed as one of a cone or a double cone.

10. The root canal instrument of claim 1, wherein said instrument is made of nickel-titanium.

11. The root canal instrument of claim 1, wherein at least the head is coated with titanium nitride.

12. The root canal instrument of claim 1, wherein said instrument is made of a stainless steel.
